(19) United States
(12) Patent Application Publication
(10) Pub. No.: US 2023/0040994 A1
(43) Pub. Date: Feb. 9, 2023

(54) INFORMATION PROCESSING APPARATUS, INFORMATION PROCESSING SYSTEM, INFORMATION PROCESSING PROGRAM, AND INFORMATION PROCESSING METHOD

(71) Applicant: Sony Semiconductor Solutions Corporation, Kanagawa (JP)

(72) Inventor: Dai Matsunaga, Kanagawa (JP)

(73) Assignee: Sony Semiconductor Solutions Corporation, Kanagawa (JP)

(21) Appl. No.: 17/787,083

(22) PCT Filed: Dec. 16, 2020
(86) PCT No.: PCT/JP2020/046928

§ 371 Date: Jun. 17, 2022

(30) Foreign Application Priority Data
Dec. 27, 2019 (JP) 2019-239265

(51) Int. Cl. G06T 7/70; G06V 10/25; G06V 10/70; G01S 13/89; G01S 15/89; G01S 17/86

(52) U.S. Cl. CPC G06T 7/70; G06V 10/25; G06V 10/70; G01S 13/89; G01S 15/89; G01S 17/86; G06V 2201/07; G06T 2207/30252

(57) ABSTRACT

A processing load in a case where a plurality of different sensors is used can be reduced. An information processing apparatus according to an embodiment includes: a recognition processing unit (15, 40b) configured to perform recognition processing for recognizing a target object by adding, to an output of a first sensor (23), region information that is generated according to object likelihood detected in a process of object recognition processing based on an output of a second sensor (21) different from the first sensor.

### FIELD

The present disclosure relates to an information processing apparatus, an information processing system, an information processing program, and an information processing method.

### BACKGROUND

Technologies for detecting an object with a sensor such as an image sensor or a millimeter-wave radar are known. As sensors for detecting an object, there are sensors of various detection methods, and the sensors are suitable for different situations in some cases. Thus, technologies have been proposed for detecting an object by using, in combination, the sensors different in detection method.

### CITATION LIST

### Patent Literature

Patent Literature 1: WO 17/057056 A

### SUMMARY

### Technical Problem

In using, in combination, a plurality of sensors different in detection method, when detection processing is performed by using all the outputs of the sensors, the detection processing load may increase. In order to avoid the increase in detection processing load, it is possible to use a method in which a detection window is set for the output of the sensors and the range of the detection processing is limited. However, the method for setting the detection window has not been defined.

An object of the present disclosure is to provide an information processing apparatus, an information processing system, an information processing program, and an information processing method that are capable of reducing the processing load in a case where a plurality of different sensors is used.

### Solution to Problem

For solving the problem described above, an information processing apparatus according to one aspect of the present disclosure has a recognition processing unit configured to perform recognition processing for recognizing a target object by adding, to an output of a first sensor, region information that is generated according to object likelihood detected in a process of object recognition processing based on an output of a second sensor different from the first sensor.

### BRIEF DESCRIPTION OF DRAWINGS

FIG. 1 is a block diagram illustrating an example of a schematic configuration of a vehicle control system.

FIG. 2 is a functional block diagram of an example for explaining the functions of a vehicle-exterior-information detection unit in a vehicle control system.

FIG. 3 is a diagram illustrating an example of the configuration of an object recognition model used in a recognition processing unit.

FIG. 4 is a block diagram illustrating an example of the configuration of a learning system.

FIG. 5 is a block diagram illustrating an example of the hardware configuration of a vehicle-exterior-information detection unit applicable to each embodiment.

FIG. 6 is a diagram schematically illustrating an object recognition model according to an embodiment of the present disclosure.

FIG. 7 is a diagram illustrating a configuration of an example of an object recognition model according to a first embodiment.

FIG. 8 is a diagram illustrating a configuration of an example of a combining unit according to the first embodiment.

FIG. 9 is a schematic diagram for explaining a first example of an attention map according to an object recognition model of the first embodiment.

FIG. 10 is a schematic diagram for explaining a second example of an attention map according to an object recognition model of the first embodiment.

FIG. 11 is a diagram illustrating a configuration of an example of an object recognition model according to a second embodiment.

FIG. 12 is a diagram illustrating a configuration of an example of an object recognition model according to a third embodiment.

FIG. 13 is a diagram illustrating a configuration of an example of a combining unit according to the third embodiment.

FIG. 14 is a diagram illustrating a configuration of an example of an object recognition model according to a fourth embodiment.

FIG. 15 is a diagram illustrating a configuration of an example of an object recognition model according to a fifth embodiment.

FIG. 16 is a block diagram of an example illustrating a first example of a vehicle-exterior-information detection unit and a data acquisition unit according to a sixth embodiment.

FIG. 17 is a block diagram of an example illustrating a second example of a vehicle-exterior-information detection unit and a data acquisition unit according to the sixth embodiment.

FIG. 18 is a block diagram of an example illustrating a third example of a vehicle-exterior-information detection unit and a data acquisition unit according to the sixth embodiment.

FIG. 19 is a block diagram of an example illustrating a fourth example of a vehicle-exterior-information detection unit and a data acquisition unit according to the sixth embodiment.

### DESCRIPTION OF EMBODIMENTS

Hereinafter, embodiments of the present disclosure are described in detail with reference to the drawings. In the following embodiments, the same parts are denoted with the same reference numerals and repeated explanation of these parts is omitted.

Hereinafter, the embodiments of the present disclosure are described in the following order.

1. Technology applicable to each embodiment

1-1. Example of vehicle-mounted system

1-2. Outline of functions

1-3. Example of hardware configuration

2. Outline of embodiments of present disclosure

3. First Embodiment

3-1. Specific examples

4. Second Embodiment

5. Third Embodiment

6. Fourth Embodiment

7. Fifth Embodiment

8. Sixth Embodiment

8-1. First example

8-2. Second example

8-3. Third example

8-4. Fourth example

8-5. Fifth example

8-6. Sixth example

### 1. Technology Applicable to Each Embodiment

Prior to the description of each embodiment of the present disclosure, a technology applicable to each embodiment of the present disclosure is described for easy understanding.

### 1-1. Example of Vehicle-Mounted System

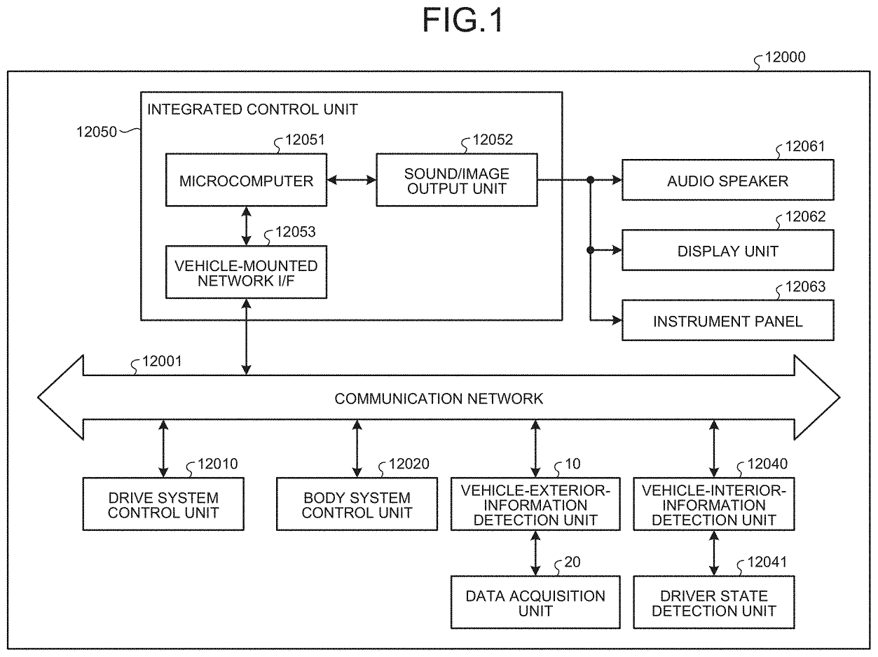

First, a vehicle-mounted system applicable to each embodiment of the present disclosure is schematically described. FIG. 1 is a block diagram illustrating an example of a schematic configuration of a vehicle control system which is an example of the vehicle-mounted system applicable to each embodiment according to the present disclosure.

A vehicle control system 12000 includes a plurality of electronic control units connected to one another via a communication network 12001. In the example illustrated in FIG. 1, the vehicle control system 12000 includes a drive system control unit 12010, a body system control unit 12020, a vehicle-exterior-information detection unit 10, a vehicle-interior-information detection unit 12040, and an integrated control unit 12050. Further, as the functional configuration of the integrated control unit 12050, a microcomputer 12051, a sound/image output unit 12052, and a vehicle-mounted network interface (I/F) 12053 are illustrated.

The drive system control unit 12010 controls the operation of devices related to the drive system of a vehicle in accordance with a variety of programs. For example, the drive system control unit 12010 functions as a control device for a driving force generation device, such as an internal-combustion engine and a driving motor, which generates a driving force of the vehicle, a driving force transmitting mechanism for transmitting the driving force to wheels, a steering mechanism for adjusting the steering angle of the vehicle, and a braking device for generating a braking force of the vehicle.

The body system control unit 12020 controls the operation of a variety of devices equipped in the vehicle body in accordance with a variety of programs. For example, the body system control unit 12020 functions as a control device for a keyless entry system, a smart key system, a power window device, or various lamps including a headlamp, a tail lamp, a brake lamp, a blinker, and a fog lamp. In such a case, the body system control unit 12020 receives an input of a radio wave sent from a mobile device functioning as a key or signals of the switches. The body system control unit 12020 receives the inputs of the radio wave or the signals to control a door lock device, the power window device, the lamps, and so on of the vehicle.

The vehicle-exterior-information detection unit 10 detects information regarding outside the vehicle on which the vehicle control system 12000 is mounted. For example, a data acquisition unit 20 is connected to the vehicle-exterior-information detection unit 10. In the vehicle-exterior-information detection unit 10, the data acquisition unit 20 includes a variety of sensors with which to monitor the situation outside the vehicle. For example, the data acquisition unit 20 may include an optical sensor that receives visible light or non-visible light such as an infrared ray and outputs an electrical signal based on the amount of light received, and the vehicle-exterior-information detection unit 10 receives an image captured by the optical sensor. Further, the data acquisition unit 20 may further include a sensor that monitors the external situation in another method such as a millimeter-wave radar, light detection and ranging or laser imaging detection and ranging (LiDAR), or an ultrasonic sensor.

The data acquisition unit 20 is provided in, for example, a front nose of a vehicle 12100, a side mirror thereof, an upper part of a front glass inside the vehicle, or the like with a region ahead of the vehicle regarded as the data acquisition direction. The vehicle-exterior-information detection unit 10 may perform distance detection processing or detection processing of an object such as a person, a vehicle, an obstacle, a sign, or a character on the road surface on the basis of outputs of the sensors received from the data acquisition unit 20.

The vehicle-interior-information detection unit 12040 detects information regarding inside the vehicle. For example, a driver state detection unit 12041 for detecting the state of the driver is connected to the vehicle-interior-information detection unit 12040. The driver state detection unit 12041 includes, for example, a camera for capturing an image of the driver, and the vehicle-interior-information detection unit 12040 may calculate a degree of fatigue or a degree of concentration of the driver, or, alternatively, may judge whether or not the driver is dozing off on the basis of detection information inputted from the driver state detection unit 12041.

The microcomputer 12051 can compute a control target value of the driving force generation device, the steering mechanism, or the braking device on the basis of vehicle-exterior-information and vehicle-interior information acquired by the vehicle-exterior-information detection unit 10 or the vehicle-interior-information detection unit 12040 and output a control command to the drive system control unit 12010. For example, the microcomputer 12051 can perform a cooperative control intended to implement the functions of an advanced driver-assistance system (ADAS) including collision avoidance or shock mitigation for the vehicle, traveling after a leading vehicle based on a distance between vehicles, traveling while maintaining a vehicle speed, a warning of collision of the vehicle, a warning of deviation of the vehicle from a lane, and the like.

Further, the microcomputer 12051 can perform a cooperative control intended to achieve automated driving that is autonomous traveling without an operation performed by a driver by controlling the driving force generation device, the steering mechanism, or the braking device on the basis of the information regarding the surroundings of the vehicle acquired by the vehicle-exterior-information detection unit 10 or the vehicle-interior-information detection unit 12040.

The microcomputer 12051 can also output a control command to the body system control unit 12020 on the basis of the vehicle-exterior-information acquired by the vehicle-exterior-information detection unit 10. For example, the microcomputer 12051 can perform a cooperative control intended to prevent glare, such as switching from a high beam to a low beam by controlling the headlamp depending on the position of a leading vehicle or an oncoming vehicle detected by the vehicle-exterior-information detection unit 10.

The sound/image output unit 12052 sends, for a person on board in the vehicle or the outside the vehicle, an output signal of at least one of a sound and an image to an output device to which visual or audio information can be sent. FIG. 1 exemplifies, as the output device, an audio speaker 12061, a display unit 12062, and an instrument panel 12063. The display unit 12062 may include, for example, at least one of an on-board display and a head-up display.

### 1-2. Outline of Functions

Next, an example of the functions of the vehicle-exterior-information detection unit 10 applicable to each embodiment of the present disclosure is schematically described.

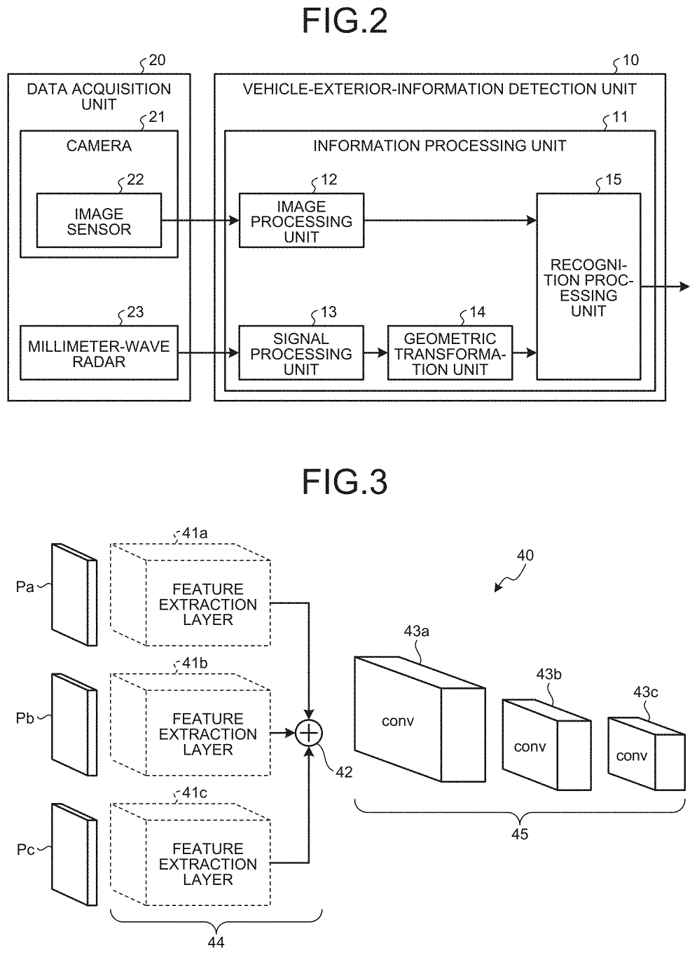

FIG. 2 is a functional block diagram of an example for explaining the functions of the vehicle-exterior-information detection unit 10 in the vehicle control system 12000 of FIG. 1. In FIG. 2, the data acquisition unit 20 includes a camera 21 and a millimeter-wave radar 23. The vehicle-exterior-information detection unit 10 includes an information processing unit 11. The information processing unit 11 includes an image processing unit 12, a signal processing unit 13, a geometric transformation unit 14, and a recognition processing unit 15.

The camera 21 includes an image sensor 22. The image sensor 22 can be any type of image sensor such as a CMOS image sensor or a CCD image sensor. The camera 21 (image sensor 22) captures an image of a region situated ahead of the vehicle on which the vehicle control system 12000 is mounted, and supplies the obtained image (hereinafter, referred to as a captured image) to the image processing unit 12.

The millimeter-wave radar 23 senses the region situated ahead of the vehicle, and the sensed range and the sensed range of the camera 21 overlap at least partially. For example, the millimeter-wave radar 23 sends a transmission signal including a millimeter-wave to the front of the vehicle, and receives, using a reception antenna, a received signal that is a signal reflected off an object (reflector) present ahead of the vehicle. For example, a plurality of reception antennas is provided at predetermined intervals in the lateral direction (width direction) of the vehicle. Further, a plurality of reception antennas may also be provided in the height direction. The millimeter-wave radar 23 supplies the signal processing unit 13 with data (hereinafter, referred to as millimeter-wave data) that chronologically indicates the strength of a received signal received by each reception antenna.

Note that the transmission signal of the millimeter-wave radar 23 is scanned in a predetermined angular range, for example, in a two-dimensional plane to form a fan-like sensed range. This is scanned in the vertical direction to obtain a bird's-eye view having three-dimensional information.

The image processing unit 12 performs predetermined image processing on the captured image. For example, the image processing unit 12 performs thinning processing, filtering processing, or the like on pixels of the captured image in accordance with the size of an image that the recognition processing unit 15 can process, and reduces the number of pixels of the captured image (reduces the resolution). The image processing unit 12 supplies the captured image with resolution lowered (hereinafter, referred to as a low-resolution image) to the recognition processing unit 15.

The signal processing unit 13 performs predetermined signal processing on the millimeter-wave data to generate a millimeter-wave image that is an image indicating the result of sensing performed by the millimeter-wave radar 23. Note that the signal processing unit 13 generates, for example, a plural-channel (ch) millimeter-wave image including a signal strength image and a speed image. The signal strength image is a millimeter-wave image indicating the position of each object that is present ahead of the vehicle and the strength of a signal that is reflected from each object (received signal). The speed image is a millimeter-wave image indicating the position of each object that is present ahead of the vehicle and a relative speed of each object to the vehicle.

The geometric transformation unit 14 performs a geometric transformation on the millimeter-wave image to transform the millimeter-wave image into an image having the same coordinate system as that of the captured image. In other words, the geometric transformation unit 14 transforms the millimeter-wave image into an image viewed from the same viewpoint as the captured image (hereinafter, referred to as a geometrically transformed millimeter-wave image). More specifically, the geometric transformation unit 14 transforms the coordinate system of the signal strength image and the speed image from the coordinate system of the millimeter-wave image to the coordinate system of the captured image. Note that the signal strength image and the speed image that have been subjected to the geometric transformation are referred to as a geometrically transformed signal strength image and a geometrically transformed speed image, respectively. The geometric transformation unit 14 supplies the geometrically transformed signal strength image and the geometrically transformed speed image to the recognition processing unit 15.

The recognition processing unit 15 uses a recognition model obtained in advance through machine learning to perform processing of recognizing a target object that is present ahead of the vehicle on the basis of the low-resolution image, the geometrically transformed signal strength image, and the geometrically transformed speed image. The recognition processing unit 15 supplies data indicating the recognition result of the target object to the integrated control unit 12050 via the communication network 12001.

Note that the target object is an object to be recognized by the recognition processing unit 15, and any object can be set to be the target object. However, it is desirable that an object that includes a portion having a high reflectance of a transmission signal of the millimeter-wave radar 23 is set to be the target object. Hereinafter, the case in which the target object is a vehicle is described as an appropriate example.

FIG. 3 illustrates an example of the configuration of the object recognition model 40 used in the recognition processing unit 15.

The object recognition model 40 is a model obtained by machine learning. Specifically, the object recognition model 40 is a model obtained by deep learning which is a type of machine learning using a deep neural network. More specifically, the object recognition model 40 includes a single shot multi-box detector (SSD) which is one of the object recognition models using the deep neural network. The object recognition model 40 includes a feature-amount extraction unit 44 and a recognition unit 45.

The feature-amount extraction unit 44 includes a feature extraction layer 41a to a feature extraction layer 41c that are convolutional layers using a convolutional neural network, and an addition unit 42. The feature extraction layer 41a extracts a feature amount of a captured image Pa to generate a feature map that two-dimensionally represents the distribution of the feature amount (hereinafter, referred to as a captured image feature map). The feature extraction layer 41a supplies the captured image feature map to the addition unit 42.

The feature extraction layer 41b extracts a feature amount of a geometrically transformed signal strength image Pb to generate a feature map that two-dimensionally represents the distribution of the feature amount (hereinafter, referred to as a signal strength image feature map). The feature extraction layer 41b supplies the signal strength image feature map to the addition unit 42.

The feature extraction layer 41c extracts a feature amount of a geometrically transformed speed image Pc to generate a feature map that two-dimensionally represents the distribution of the feature amount (hereinafter, referred to as a speed image feature map). The feature extraction layer 41c supplies the speed image feature map to the addition unit 42.

The addition unit 42 adds the captured image feature map, the signal strength image feature map, and the speed image feature map together to generate a combining feature map. The addition unit 42 supplies the combining feature map to the recognition unit 45.

The recognition unit 45 includes a convolutional neural network. Specifically, the recognition unit 45 includes a convolutional layer 43a to a convolutional layer 43c.

The convolutional layer 43a performs a convolution operation on the combining feature map. The convolutional layer 43a performs processing of recognizing the target object on the basis of the combining feature map on which the convolution operation has been performed. The convolutional layer 43a supplies the convolutional layer 43b with the combining feature map on which the convolution operation has been performed.

The convolutional layer 43b performs a convolution operation on the combining feature map provided by the convolutional layer 43a. The convolutional layer 43b performs processing of recognizing the target object on the basis of the combining feature map on which the convolution operation has been performed. The convolutional layer 43a supplies the convolutional layer 43c with the combining feature map on which the convolution operation has been performed.

The convolutional layer 43c performs a convolution operation on the combining feature map provided by the convolutional layer 43b. The convolutional layer 43b performs processing of recognizing the target object on the basis of the combining feature map on which the convolution operation has been performed.

The object recognition model 40 outputs data indicating a result of the recognition of the target object that is performed by the convolutional layer 43a to the convolutional layer 43c.

Note that the size (the number of pixels) of the combining feature map decreases in order from the convolutional layer 43a, and is the smallest in the convolutional layer 43c. Further, as the size of the combining feature map increases, the recognition accuracy of a target object having a small size, as viewed from the vehicle (camera), increases, and as the size of the combining feature map decreases, the recognition accuracy of a target object having a large size, as viewed from the vehicle, increases. Thus, for example, in a case where the target object is a vehicle, a small vehicle in a distant location is easily recognized in the combining feature map having a large size, and a large vehicle nearby is easily recognized in the combining feature map having a small size.

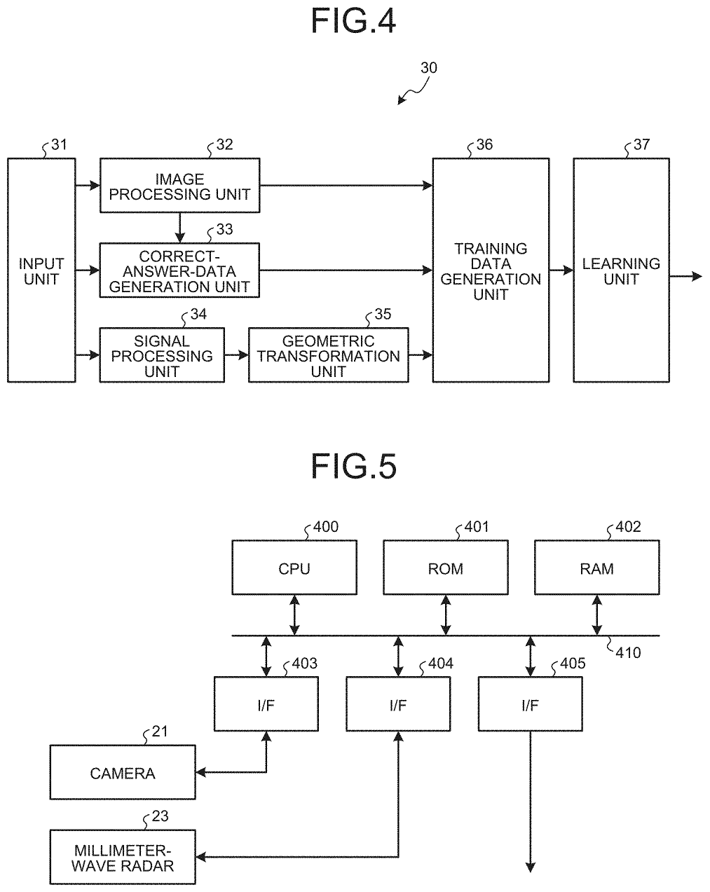

FIG. 4 is a block diagram illustrating an example of the configuration of a learning system 30. The learning system 30 performs learning processing on the object recognition model 40 of FIG. 3. The learning system 30 includes an input unit 31, an image processing unit 32, a correct-answer-data generation unit 33, a signal processing unit 34, a geometric transformation unit 35, a training data generation unit 36, and a learning unit 37.

The input unit 31 includes various input devices, and is used for input of data necessary to generate training data, user operation, and so on. For example, in a case where a captured image is inputted, the input unit 31 supplies the captured image to the image processing unit 32. For example, in a case where millimeter-wave data is inputted, the input unit 31 supplies the millimeter-wave data to the signal processing unit 34. For example, the input unit 31 supplies the correct-answer-data generation unit 33 and the training data generation unit 36 with data indicating an instruction of a user that is inputted by an operation performed by the user.

The image processing unit 32 performs processing similar to the processing performed by the image processing unit 12 of FIG. 2. Specifically, the image processing unit 32 performs predetermined image processing on a captured image to generate a low-resolution image. The image processing unit 32 supplies the low-resolution image to the correct-answer-data generation unit 33 and the training data generation unit 36.

The correct-answer-data generation unit 33 generates correct answer data on the basis of the low-resolution image. For example, the user designates a location of a vehicle in the low-resolution image through the input unit 31. The correct-answer-data generation unit 33 generates correct answer data indicating the location of the vehicle in the low-resolution image on the basis of the location of the vehicle designated by the user. The correct-answer-data generation unit 33 supplies the correct answer data to the training data generation unit 36.

The signal processing unit 34 performs processing similar to the processing performed by the signal processing unit 13 of FIG. 2. Specifically, the signal processing unit 34 performs predetermined signal processing on the millimeter-wave data to generate a signal strength image and a speed image. The signal processing unit 34 supplies the signal strength image and the speed image to the geometric transformation unit 35.

The geometric transformation unit 35 performs processing similar to the processing performed by the geometric transformation unit 14 of FIG. 2. Specifically, the geometric transformation unit 35 performs a geometric transformation on the signal strength image and the speed image. The geometric transformation unit 35 supplies the geometrically transformed signal strength image and the geometrically transformed speed image that have been subjected to the geometric transformation to the training data generation unit 36.

The training data generation unit 36 generates input data including the low-resolution image, the geometrically transformed signal strength image, and the geometrically transformed speed image, and training data including the correct answer data. The training data generation unit 36 supplies the training data to the learning unit 37.

The learning unit 37 uses the training data to perform learning processing on the object recognition model 40. The learning unit 37 outputs the object recognition model 40 that has learned.

Here, the learning processing on an object recognition model performed by the learning system 30 is described.

Note that, before the start of the processing, data used to generate training data is collected. For example, in a state where the vehicle is actually traveling, the camera 21 and the millimeter-wave radar 23 provided in the vehicle perform sensing with respect to a region situated ahead of the vehicle. Specifically, the camera 21 captures an image of the region situated ahead of the vehicle, and stores the captured image thus obtained into a storage unit. The millimeter-wave radar 23 detects an object present ahead of the vehicle, and stores the millimeter-wave data thus obtained in the storage unit. The training data is generated on the basis of the captured image and the millimeter-wave data accumulated in the storage unit.

First, the learning system 30 generates training data. For example, the user inputs, to the learning system 30 via the input unit 31, the captured image and the millimeter-wave data that are acquired substantially simultaneously. In other words, the captured image and the millimeter-wave data obtained by performing sensing at substantially the same point in time are inputted to the learning system 30. The captured image is supplied to the image processing unit 32, and the millimeter-wave data is supplied to the signal processing unit 34.

The image processing unit 32 performs image processing such as the thinning processing on the captured image to generate a low-resolution image. The image processing unit 32 supplies the low-resolution image to the correct-answer-data generation unit 33 and the training data generation unit 36.

The signal processing unit 34 performs predetermined signal processing on the millimeter-wave data to estimate the position and speed of the object that has reflected the transmission signal ahead of the vehicle. The position of the object is represented by, for example, a distance from the vehicle to the object and a direction (angle) of the object with respect to an optical axis direction (traveling direction of the vehicle) of the millimeter-wave radar 23. Note that the optical axis direction of the millimeter-wave radar 23 is equal to the center direction of the range in which the transmission signal is radiated, for example, in a case where the transmission signal is radially transmitted, and is equal to the center direction of the range in which the transmission signal is scanned in a case where the transmission signal is scanned. The speed of the object is represented by, for example, a relative speed of the object to the vehicle.

The signal processing unit 34 generates a signal strength image and a speed image on the basis of a result of the estimation of the position and speed of the object. The signal processing unit 34 supplies the signal strength image and the speed image to the geometric transformation unit 35. Although not illustrated, the speed image is an image showing the position of the object present ahead of the vehicle and the distribution of the relative speed of each object in a bird's-eye view similarly to the signal strength image.

The geometric transformation unit 35 performs a geometric transformation on the signal strength image and the speed image, and transforms the signal strength image and the speed image into an image having the same coordinate system as that of the captured image, and thereby generates a geometrically transformed signal strength image and a geometrically transformed speed image. The geometric transformation unit 35 supplies the geometrically transformed signal strength image and the geometrically transformed speed image to the training data generation unit 36.

In the geometrically transformed signal strength image, a portion having a higher signal strength is brighter, and a portion having a lower signal strength is darker. In the geometrically transformed speed image, a portion having a higher relative speed is brighter, a portion having a lower relative speed is darker, and a portion where the relative speed is undetectable (no object is present) is filled in black. As described above, the geometric transformation on the millimeter-wave image (the signal strength image and the speed image) represents not only the position of the object in the transverse direction and the depth direction but also the position of the object in the height direction.

However, the resolution of the millimeter-wave radar 23 in the height direction decreases as the distance increases. Thus, the height of an object that is far away is sometimes detected to be larger than the actual height.

In contrast, in the case of geometric transformation on the millimeter-wave image, the geometric transformation unit 35 limits the height of the object that is present a predetermined distance or more away. Specifically, in the case of geometric transformation on the millimeter-wave image, in a case where the height of the object that is present a predetermined distance or more away exceeds a predetermined upper limit value, the geometric transformation unit 35 limits the height of the object to the upper limit value and performs the geometric transformation. This prevents, for example, in a case where the target object is a vehicle, the occurrence of erroneous recognition due to the detection of the height of a vehicle in a distant location to be larger than the actual height.

The training data generation unit 36 generates input data including the captured image, the geometrically transformed signal strength image, and the geometrically transformed speed image, and training data including the correct answer data. The training data generation unit 36 supplies the training data thus generated to the learning unit 37.

Next, the learning unit 37 causes the object recognition model 40 to perform learning. Specifically, the learning unit 37 inputs the input data included in the training data to the object recognition model 40. The object recognition model 40 performs processing of recognizing the target object to output data indicating a result of the recognition. The learning unit 37 compares the result of the recognition of the object recognition model 40 with the correct answer data, and adjusts parameters and the like of the object recognition model 40 so as to reduce the error.

Next, the learning unit 37 determines whether or not the learning is to be continuously performed. For example, in a case where the learning performed by the object recognition model 40 has not come to an end, the learning unit 37 determines that the learning is to be continuously performed, and the processing returns to the learning data generation processing performed at the beginning. Thereafter, each processing described above is repeatedly executed until it is determined that the learning is to be terminated.

On the other hand, as a result of the determination by the learning unit 37, for example, in a case where the learning by the object recognition model 40 has come to an end, the learning unit 37 determines that the learning is to be terminated, and the object recognition model learning processing is terminated. As described above, the object recognition model 40 that has performed learning is generated.

### 1-3. Example of Hardware Configuration

The description goes on to an example of the hardware configuration of the vehicle-exterior-information detection unit 10 applicable to each embodiment of the present disclosure. FIG. 5 is a block diagram illustrating an example of the hardware configuration of the vehicle-exterior-information detection unit 10 applicable to each embodiment. In FIG. 5, the vehicle-exterior-information detection unit 10 includes a central processing unit (CPU) 400, a read only memory (ROM) 401, a random access memory (RAM) 402, and interfaces (I/F) 403, 404, and 405, which are connected to one another for communication via a bus 410. Note that the vehicle-exterior-information detection unit 10 may further include a storage device such as a flash memory.

The CPU 400 controls the entire operation of the vehicle-exterior-information detection unit 10 using the RAM 402 as a work memory according to a program or data stored, in advance, in the ROM 401. Here, the ROM 401 or the RAM 402 stores, in advance, the program and data for implementing the object recognition model 40 described with reference to FIGS. 2 to 4. The program is executed by the CPU 400, which constructs the object recognition model 40 in the vehicle-exterior-information detection unit 10.

The interface 403 is an interface for connecting the camera 21. The interface 404 is an interface for connecting the millimeter-wave radar 23. The vehicle-exterior-information detection unit 10 controls the camera 21 and the millimeter-wave radar 23 via the interfaces 403 and 404, and acquires captured image data (hereinafter, referred to as image data) captured by the camera 21 and millimeter-wave data acquired by the millimeter-wave radar 23. The vehicle-exterior-information detection unit 10 executes processing of recognizing an object by applying, as the input data, the image data and the millimeter-wave data to the object recognition model 40.

In FIG. 5, the interface 405 is an interface for performing communication between the vehicle-exterior-information detection unit 10 and the communication network 12001. The vehicle-exterior-information detection unit 10 sends information indicating the result of the object recognition outputted by the object recognition model 40 from the interface 405 to the communication network 12001.

### 2. Outline of Embodiments of Present Disclosure

The description goes on to an outline of the embodiments of the present disclosure. In each embodiment of the present disclosure, a detection window for detecting the target object on the basis of an output of a first sensor for detecting the target object is set on the basis of an output of a second sensor for detecting the target object in a manner different from that of the first sensor, and the processing of recognizing the target object is performed on the basis of an output of a region corresponding to the detection window in the output of the second sensor.

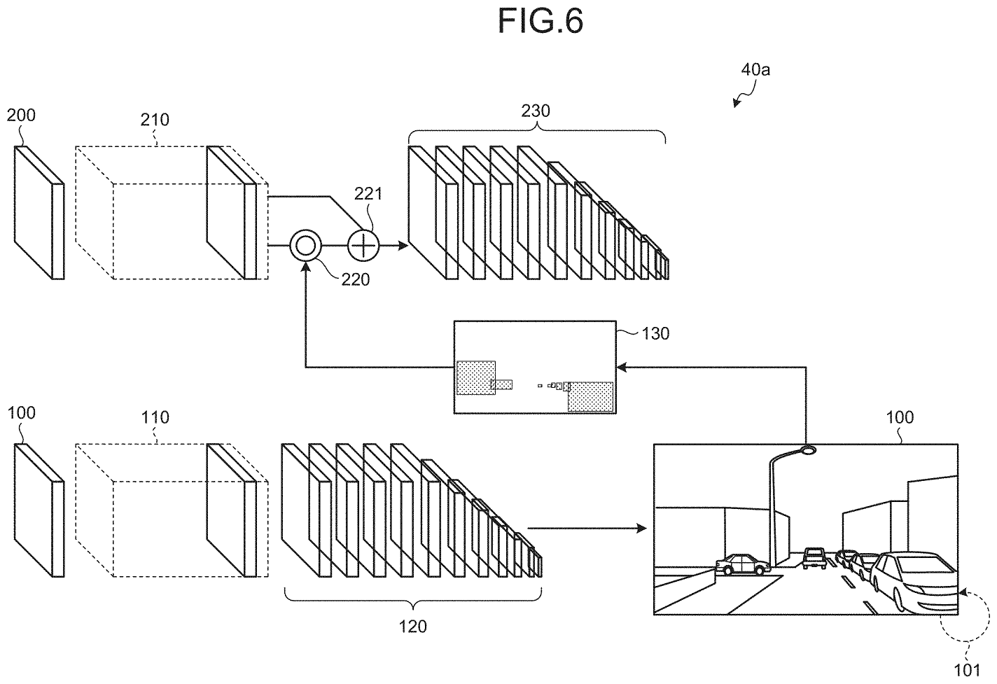

FIG. 6 is a diagram schematically illustrating the object recognition model 40 according to an embodiment of the present disclosure. In an object recognition model 40a, an image data 100 acquired from the camera 21 is inputted to a feature extraction layer 110. Further, a millimeter-wave image data 200 based on the millimeter-wave image acquired from the millimeter-wave radar 23 is inputted to a feature extraction layer 210.

The image data 100 inputted to the object recognition model 40a is shaped into data including a feature amount of 1 ch or more in the image processing unit 12, for example. The image data 100 is data in which features are extracted by the feature extraction layer 110 in the object recognition model 40a, the size is changed as necessary, and ch of the feature amount is added. The image data 100 of which features are extracted by the feature extraction layer 110 is subjected to convolutional processing in an object recognition layer 120, and a plurality of sets of object recognition layer data that is sequentially convolved is generated.

The object recognition model 40a generates an attention map 130 on the basis of the plurality of sets of object recognition layer data. The attention map 130 includes, for example, information indicating a detection window for limiting a target region for the object recognition with respect to a range indicated in the image data 100. The attention map 130 thus generated is inputted to a multiplication unit 220.

In contrast, the millimeter-wave image data 200 inputted to the object recognition model 40a is shaped into data including a feature amount of 1 ch or more by the signal processing unit 13 and the geometric transformation unit 14, for example. The millimeter-wave image data 200 is data in which features are extracted by the feature extraction layer 210 in the object recognition model 40a, the size is changed as necessary (the size is set to be the same as that of the image data 100, for example) and ch of the feature amount is added. The millimeter-wave image data 200 of each ch of which features are extracted by the feature extraction layer is inputted to the multiplication unit 220, and is multiplied for each pixel with the attention map 130. As a result, an area where the object recognition is performed is limited in the millimeter-wave image data 200. Further, the output of the multiplication unit 220 is inputted to an addition unit 221, and the output of the feature extraction layer 210 is added. The output of the addition unit 221 is inputted to the object recognition layer 230 and is subjected to the convolutional processing.

As described above, the object recognition processing is performed on the region limited by the attention map 130, leading to the reduction in the processing amount of the object recognition processing.

Note that the processing speed can be increased by using data on a past frame 101 as the image data 100.

### 3. First Embodiment

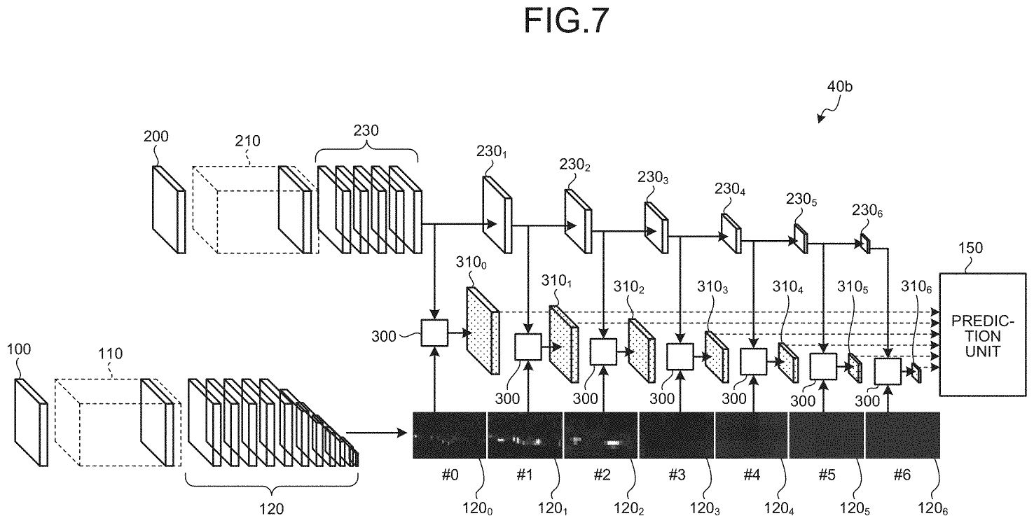

The description goes on to the first embodiment of the present disclosure. FIG. 7 is a diagram illustrating a configuration of an example of an object recognition model according to the first embodiment. Referring to FIG. 7, in an object recognition model 40b, processing in the feature extraction layers 110 and 210 and the object recognition layers 120 and 230 illustrated on the left side of FIG. 7 is equivalent to that in FIG. 6, and thus, description thereof is omitted herein.

FIG. 7 schematically illustrates, on the right side thereof, the object recognition layer 230 based on the millimeter-wave image data 200 and the object recognition layer 120 based on the image data 100. The object recognition layer 230 includes sets of object recognition layer data 230₀, 230₁, 230₂, 230₃, 230₄, 230₅, and to 230₆ that are sequentially convolved on the basis of the millimeter-wave image data 200. Further, the object recognition layer 120 includes sets of object recognition layer data 120₀, 120₁, 120₂, 120₃, 120₄, 120₅, and 120₆ that are sequentially convolved on the basis of the image data 100.

Note that, in the following description, in a case where it is not necessary to particularly distinguish the sets of object recognition layer data 120₀ to 120₆ from one another, object recognition layer data 120ₓ is described as a representative. Similarly, in a case where it is not necessary to particularly distinguish the sets of object recognition layer data 230₀ to 230₆ from one another, object recognition layer data 230ₓ is described as a representative.

In FIG. 7, specific examples of the object recognition layer data 120₀ to 120₇ are illustrated as layer (layer) images #0, #1, #2, #3, #4, #5, and #6 corresponding to the attention map. Although the details are described later, white portions of the layer images #1 and #2 of the layer images show detection windows.

That is, the object recognition layer 120 obtains object likelihood on the basis of the features of the layer images #0, #1, #2, #3, #4, #5, and #6, and determines a region having high object likelihood thus obtained. The object recognition layer 120 obtains, for the layer image #1 for example, object likelihood on the basis of the pixel information. Then, the object likelihood obtained is compared with a threshold, and a region in which the object likelihood is higher than the threshold is determined. In the example of FIG. 7, a region shown in white in the layer image #1 indicates a region having the object likelihood higher than the threshold. The object recognition layer 120 generates region information indicating the region. The region information includes information indicating a position in the layer image #1 and a value indicating the object likelihood at the position. The object recognition layer 120 sets a detection window on the basis of the region indicated in the region information and generates an attention map.

Here, the size of the sets of object recognition layer data 120₀ to 120₆ is sequentially reduced by convolution. For example, in the example of FIG. 7, the size of the layer image #0 (object recognition layer data 120₀) is set to ½ by convolution for one layer. For example, assuming that the size of the layer image #0 is 640 pixels×384 pixels, the size of the layer image #6 is 1 pixel×1 pixel by convolution (and shaping processing) of seven layers.

As described above, a layer image with a small number of convolutions and a large size can detect a smaller (distant) target object, and a layer image with a large number of convolutions and a small size can detect a larger (nearer) target object. The same applies to the sets of object recognition layer data 230₀ to 230₆ based on the millimeter-wave data.

A layer image with a large number of convolutions and a small number of pixels or a layer image with a small number of convolutions in which an object is recognized as a small object is not appropriate for use in the object recognition processing in some cases. Therefore, in the example of FIG. 7, the attention map may be generated using the number of layer images (for example, three layers of the layer images #1 to #3) according to the purpose instead of generating the attention map for all the seven layers.

The sets of object recognition layer data 120₀ to 120₇ are inputted to the corresponding combining units 300. Further, the sets of object recognition layer data 230₀ to 230₆ based on the millimeter-wave image data 200 are inputted to the corresponding combining units 300. The combining units 300 combine the sets of object recognition layer data 120₀ to 120₇ and the sets of object recognition layer data 230₀ to 230₆ thus inputted to generate combined object recognition layer data 310₀ to 310₆.

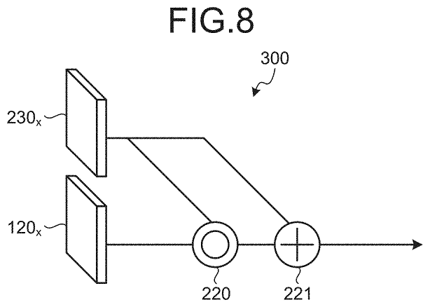

FIG. 8 is a diagram illustrating a configuration of an example of the combining unit 300 according to the first embodiment. The combining unit 300 includes the multiplication unit 220 and the addition unit 221. The multiplication unit 220 receives, at one input end, the object recognition layer data 120ₓ based on the attention map based on the image data 100. The multiplication unit 220 receives, at the other input end, the object recognition layer data 230ₓ based on the millimeter-wave image data 200. The multiplication unit 220 calculates, for each pixel, a product of the object recognition layer data 120ₓ inputted to one input end thereof and the object recognition layer data 230ₓ inputted to the other input end thereof. The calculation by the multiplication unit 220 emphasizes a region corresponding to the detection window in the millimeter-wave image data 200 (object recognition layer data 230ₓ).

The present invention is not limited thereto, and the object recognition model 40a may reduce a region outside the detection window in the millimeter-wave image data 200.

The result of multiplication by the multiplication unit 220 is inputted to one input end of the addition unit 221. The addition unit 221 receives, at the other input end, the object recognition layer data 230ₓ based on the millimeter-wave image data 200. The addition unit 221 calculates a sum of matrices for the result of multiplication by the multiplication unit 220 inputted to one input end and the object recognition layer data 230ₓ.

As described above, the processing by the multiplication unit 220 and the addition unit 221 adds, to the millimeter-wave image data 200 by the millimeter-wave radar 23 as the first sensor, region information that is generated according to the object likelihood detected in the process of the object recognition processing based on the image data 100 by the camera 21 as the second sensor different from the first sensor.

Here, the addition unit 221 performs processing of adding the original image to the result of multiplication by the multiplication unit 220. For example, in a case where the attention map is represented by a value of 0 or 1 for each pixel, for example, in a case where all the attention maps are 0 in a certain layer image, or in a region of 0 in the attention map, information is lost. Therefore, in the processing by a prediction unit 150 described later, the recognition processing on the region cannot be performed. In light of the above, the addition unit 221 adds the object recognition layer data 230ₓ based on the millimeter-wave image data 200 to avoid a situation in which data is lost in the region.

Returning back to FIG. 7, the combined object recognition layer data 310₀ to 310₆ outputted from the combining units 300 is inputted to the prediction unit 150. The prediction unit 150 performs object recognition processing on the basis of the sets of combined object recognition layer data 310₀ to 310₆ thus inputted, and predicts a class or the like of the recognized object. The result of prediction by the prediction unit 150 is outputted from the vehicle-exterior-information detection unit 10 as data indicating the recognition result of the target object, and is conveyed to the integrated control unit 12050 via, for example, the communication network 12001.

### 3-1. Specific Example

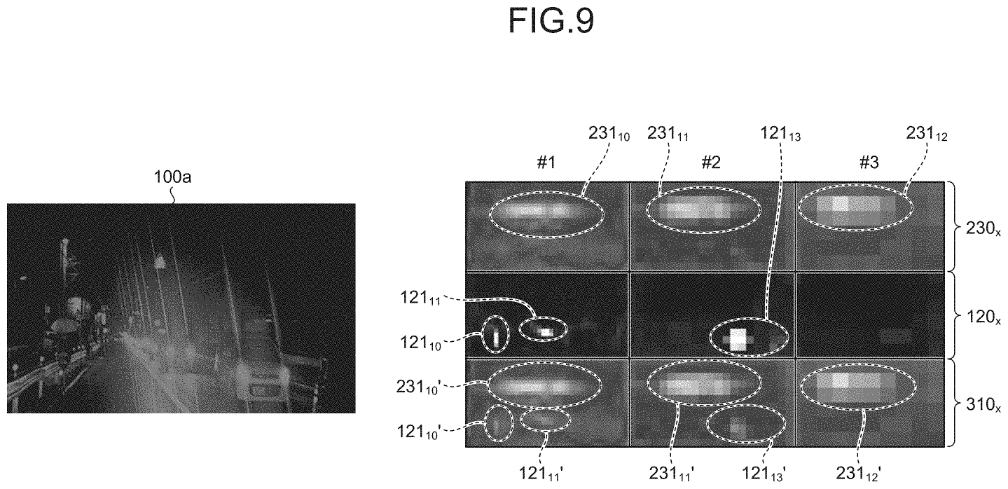

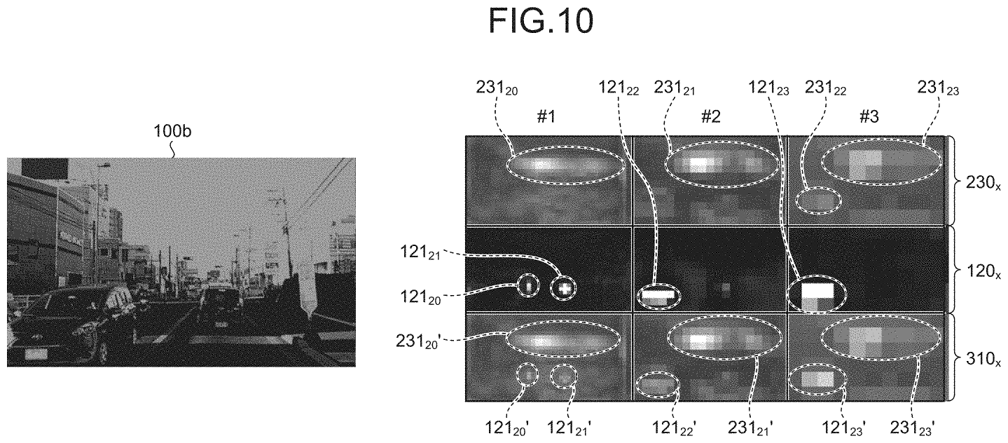

An attention map by the object recognition model 40a according to the first embodiment is described more specifically with reference to FIGS. 9 and 10.

FIG. 9 is a schematic diagram for explaining a first example of the attention map according to the object recognition model 40a of the first embodiment.

FIG. 9 illustrates, on the left side, an example of original image data 100a. FIG. 9 illustrates, on the right side, the object recognition layer data 230ₓ, the object recognition layer data 230ₓ, and the combined object recognition layer data 310ₓ from top to bottom. Further, from left to right, the object recognition layer data 230ₓ, the object recognition layer data 230ₓ, and the combined object recognition layer data 310ₓ are illustrated so as to correspond to the layer image #1 (object recognition layer data 120₁), the layer image #2 (object recognition layer data 120₂), and the layer image #3 (object recognition layer data 120₃).

Stated differently, the right diagram of FIG. 9 illustrates, at the upper part, a feature map indicating the features of the millimeter-wave image data 200, and illustrates, at the middle part, an attention map generated on the basis of the features of the image data 100. In addition, the lower part of the right diagram of FIG. 9 is the combined object recognition layer data 310ₓ obtained by combining the feature map based on the millimeter-wave image data 200 and the attention map based on the image data 100 by the combining unit 300.

Hereinafter, the object recognition layer data 230ₓ corresponding to the layer image #X is referred to as the object recognition layer data 230ₓ of the layer image #X. The combined object recognition layer data 310ₓ corresponding to the layer image #X is referred to as the combined object recognition layer data 310ₓ of the layer image #X.

Referring to FIG. 9, in the object recognition layer data 230₁ of the layer image #1, of the object recognition layer data 230ₓ, an object-like recognition result is seen in a part shown in a region 231₁₀ in the drawing. Further, the layer image #1 shows a state in which an attention map where the object likelihood of regions 121₁₀ and 121₁₁ are equal to or greater than the threshold and the regions 121₁₀ and 121₁₁ are set as the detection windows is generated. On the other hand, in combined object recognition layer data 310₁ of the layer image #1, an object-like recognition result is seen in a region 230₁ or corresponding to the region 231₁₀, and 121₁₀′ and 121₁₁′ corresponding to the regions 121₁₀ and 121₁₁, respectively.

Similarly, in the layer image #2, in the object recognition layer data 230₂ of the layer image #2, an object-like recognition result is seen in a part shown in a region 231₁₁, and the layer image #1 shows a state in which an attention map where the object likelihood of a region 121₁₃ is equal to or greater than the threshold and the region 121₁₃ is set as the detection window is generated. On the other hand, in combined object recognition layer data 310₂ of the layer image #2, an object-like recognition result is seen in a region 230₁₁′ corresponding to the region 231₁₁ and 121₁₃′ corresponding to the region 121₁₃.

As for the layer image #3, in the object recognition layer data 230₃ of the layer image #3, an object-like recognition result is seen in a part shown in a region 231₁₂ and, in the layer image #1, a region with the object likelihood equal to or greater than the threshold is not detected and no detection window is generated. In combined object recognition layer data 310₃ of the layer image #3, an object-like recognition result is seen in a region 230₁₂′ corresponding to the region 231₁₂.

Further, in the regions 121₁₀ and 121₁₁ and the region 121₁₃, white and gray regions correspond to the detection windows. In such a case, for example, a region having a higher degree of white has higher object likelihood. As an example, in the region 121₁₃, a region having a high degree of white where a light gray region having a vertical rectangular shape and a dark gray region having a horizontal rectangular shape intersect is a region having the highest object likelihood in the region 121₁₃. As described above, the detection window is set, for example, on the basis of the region information including information indicating the corresponding position in the layer image and the value indicating the object likelihood.

As described above, in the layer images #1 and #2, without calculating the object likelihood for the object recognition layer data 230ₓ based on the millimeter-wave image data 200, it is possible to generate the combined object recognition layer data 310ₓ including the region of the detection window based on the image data 100 while emphasizing a region where the object-like recognition result is seen on the basis of the millimeter-wave image data 200.

In addition, since the addition unit 221 adds the object recognition layer data 230ₓ based on the millimeter-wave image data 200, even in a case where no detection window is set in the layer image #2 as in the layer image #3, it is possible to emphasize a region where the object-like recognition result is seen on the basis of the millimeter-wave image data 200.

FIG. 10 is a schematic diagram for explaining a second example of an attention map according to the object recognition model 40a of the first embodiment. Since the meaning of each unit in FIG. 10 is similar to that in FIG. 9 described above, the description thereof is omitted herein. FIG. 10 illustrates, on the left side, an example of original image data 100b.

Referring to FIG. 10, in the object recognition layer data 230₁ of the layer image #1, of the object recognition layer data 230ₓ, an object-like recognition result is seen in a part shown in a region 231₂₀ in the drawing. Further, the layer image #1 shows a state in which an attention map where the object likelihood of regions 121₂₀ and 121₂₁ are equal to or greater than the threshold and the regions 121₂₀ and 121₂₁ are set as the detection windows is generated. On the other hand, in the combined object recognition layer data 310₁ of the layer image #1, an object-like recognition result is seen in a region 23020′ corresponding to the region 231₂₀, and 121₂₀′ and 121₂₁′ corresponding to the regions 121₂₀ and 121₂₁, respectively.

Similarly, in the layer image #2, in the object recognition layer data 230₂ of the layer image #2, an object-like recognition result is seen in a part shown in a region 231₂₁, and the layer image #2 shows a state in which an attention map where the object likelihood of a region 121₂₂ is equal to or greater than the threshold and the region 121₂₂ is set as the detection window is generated. On the other hand, in the combined object recognition layer data 310₂ of the layer image #2, an object-like recognition result is seen in a region 230₂₁′ corresponding to the region 231₂₁ and 121₂₂′ corresponding to the region 121₂₂.

In the layer image #3, in the object recognition layer data 230₃ of the layer image #3, an object-like recognition result is seen in a part shown in a region 231₂₂, and the layer image #1 shows a state in which an attention map where the object likelihood of the region 121₂₃ is equal to or greater than the threshold and the region 121₂₃ is set as the detection window is generated. On the other hand, in the combined object recognition layer data 310₃ of the layer image #3, an object-like recognition result is seen in a region 230₂₁′ corresponding to a region 231₂₃ and 121₂₃′ corresponding to the region 121₂₃.

As with the first example described above, in the second example, in the layer images #1 to #3, without calculating the object likelihood for the object recognition layer data 230ₓ based on the millimeter-wave image data 200, it is possible to generate the combined object recognition layer data 310ₓ including the region of the detection window based on the image data 100 while emphasizing a region where the object-like recognition result is seen on the basis of the millimeter-wave image data 200.

As described above, according to the first embodiment, even if the millimeter-wave image data 200 alone is a weak feature, it is possible to improve the performance of the object recognition by emphasizing the feature using the attention map based on the image data 100 captured by the camera 21. In addition, this makes it possible to reduce the load related to the recognition processing in a case where a plurality of different sensors is used.

Note that, in the example of FIG. 7, the sets of combined object recognition layer data 310ₓ of the convolutional layers obtained by combining, by the combining unit 300, the object recognition layer data 120ₓ and the object recognition layer data 230ₓ that have convolutional layers corresponding to each other are inputted to the prediction unit 150; however, this is not limited to this example. For example, the combined object recognition layer data 310ₓ obtained by combining, by the combining unit 300, the object recognition layer data 120ₓ and the object recognition layer data 230ₓ that have different convolutional layers (for example, the object recognition layer data 120₁ and the object recognition layer data 230₂) can be inputted to the prediction unit 150. In such a case, it is preferable to make the sizes of the object recognition layer data 120ₓ and the object recognition layer data 230ₓ, which are to be combined by the combining unit 300, the same. Further, it is possible for the combining unit 300 to combine a part of the sets of object recognition layer data 120ₓ and the sets of object recognition layer data 230ₓ to generate the combined object recognition layer data 310ₓ. At this time, it is possible to select data in which the convolutional layers correspond to each other one by one from among the sets of object recognition layer data 120ₓ and the sets of object recognition layer data 230ₓ and combine the selected data in the combining unit 300, or, alternatively, it is possible to select a plurality of sets of the respective data and combine the selected data in the combining unit 300.

### 4. Second Embodiment

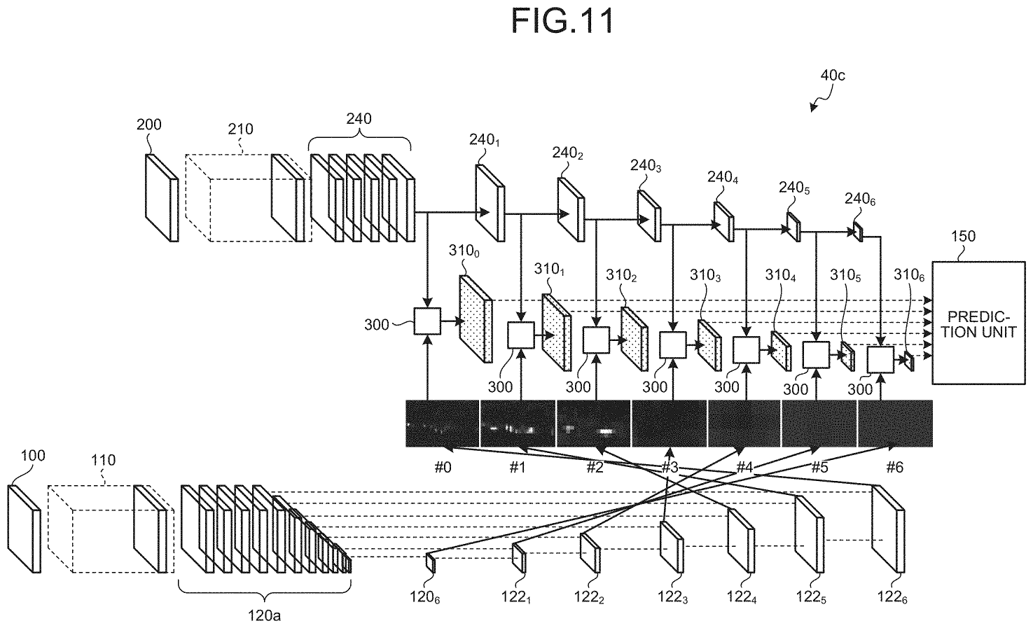

The description goes on to the second embodiment of the present disclosure. In the second embodiment, an example is described in which an attention map is generated in a method different from that of the first embodiment described above. FIG. 11 is a diagram illustrating a configuration of an example of an object recognition model according to the second embodiment.

In FIG. 11, as described above, in an object recognition model 40c, an object recognition layer 120a performs convolutional processing on the basis of the image data 100 to generate the sets of object recognition layer data 120₀ to 120₆ (not illustrated). Here, the object recognition layer 120a, for example, doubles the size of the object recognition layer data 120₆ having the deepest convolutional layer and the smallest size to generate an object recognition layer data 122₁ for the next layer.

In such a case, since the newly generated object recognition layer data 122₁ takes over the features of the object recognition layer data 120₆ having the smallest size among the object recognition layers 120₀ to 120₆, the features of the object recognition layer data 122₁ are weak. Therefore, the object recognition layer 120a connects, to the object recognition layer data 120₆, the object recognition layer data 120₅ that has the second deepest convolutional layer after the object recognition layer data 120₆ and has a size, for example, twice the size of the object recognition layer data 120₆ and generates the new object recognition layer data 122₁.

Next, similarly, the object recognition layer 120a, for example, doubles the size of the object recognition layer data 122₁ generated and connects the resultant to the corresponding object recognition layer data 120₅ to generate new object recognition layer data 122₂. As described above, the object recognition layer 120a according to the second embodiment repeats the processing of, for example, doubling the size of the generated object recognition layer data 122ₓ and combining the resultant and the corresponding object recognition layer data 120ₓ to newly generate object recognition layer data 122ₓ₊₁.

The object recognition layer 120a generates an attention map on the basis of the object recognition layer data 120₆, 122₁, 122₂, 122₃, 122₄, 122₅, and 122₆ generated by sequentially doubling the size as described above. At this time, the object recognition layer data 122₆ having the largest size is put into the layer image #0 to generate an attention map for the layer image #0. The object recognition layer data 122₅ having the second largest size is put into the layer image #1 to generate an attention map for the layer image #1. Thereafter, the sets of object recognition layer data 122₄, 122₃, 122₂, 122₁, and 120₆ are put, in order of decreasing size, into the layer images #2, #3, #4, #5, and #6 to generate attention maps for the layer images #2 to #6.

As described above, in the second embodiment, the object recognition layer 120a generates a new attention map by creating and putting the same by machine learning. As a result, it is possible to reduce false positive (FP) caused by a highly reflective object other than the recognition target, such as a guardrail or a curbstone, and to improve the performance of the object recognition by the millimeter-wave image data 200 alone. On the other hand, in the second embodiment, since the attention map is generated by connecting data to the object recognition layer data 120₆ on which convolution has been performed up to a deep convolutional layer with respect to the image data 100, the features of an object whose image is difficult to be caught by the camera 21 are weakened. For example, it is difficult to recognize an object hidden by water droplets, fog, or the like. In light of the above, it is preferable to switch, depending on the environment, between the method for generating an attention map according to the second embodiment and, for example, the method for generating an attention map according to the first embodiment.

### 5. Third Embodiment

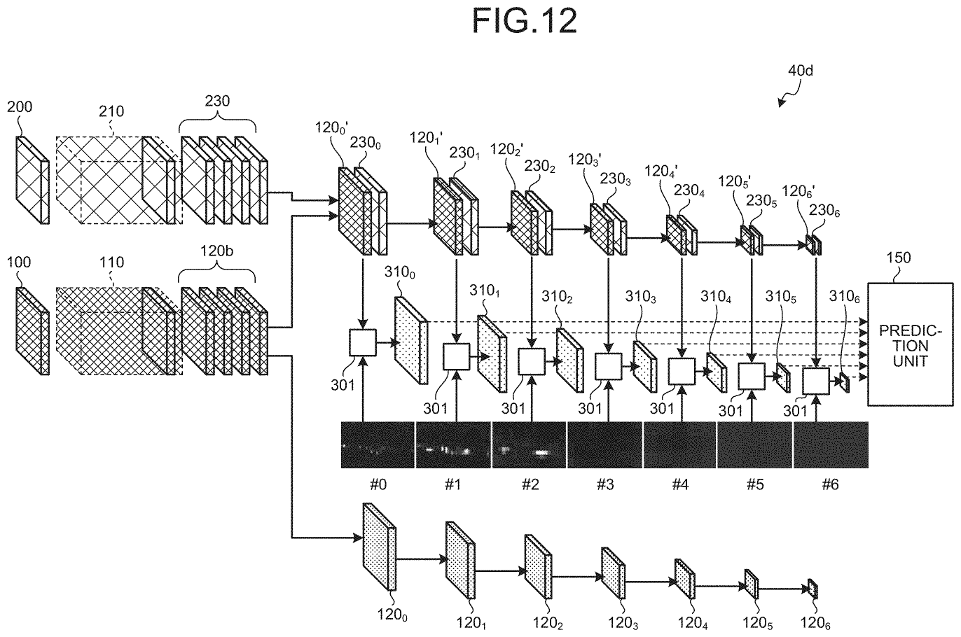

The description goes on to the third embodiment of the present disclosure. In the third embodiment, an example is described in which the sets of object recognition layer data 230₀ to 230₆ based on the millimeter-wave image data 200 are multiplied by the attention maps (sets of object recognition layer data 120₀ to 120₆) based on the image data 100. FIG. 12 is a diagram illustrating a configuration of an example of an object recognition model according to the third embodiment.

In an object recognition model 40d illustrated in FIG. 12, the object recognition layer 230 generates the sets of object recognition layer data 230₀ to 230₆ on the basis of the millimeter-wave image data 200 in the same manner as that in the first embodiment. On the other hand, an object recognition layer 120b generates the sets of object recognition layer data 120₀ to 120₆ and sets of object recognition layer data 120₀′ to 120₆′ on the basis of the image data 100.

Here, the sets of object recognition layer data 120₀ to 120₆ are data in which parameters are adjusted so that the object recognition is performed by the image data 100 alone. On the other hand, the sets of object recognition layer data 120₀′ to 120₆′ are data in which parameters are adjusted so that the object recognition is performed using both the millimeter-wave image data 200 and the image data 100. For example, in the learning system 30 described with reference to FIG. 4, for identical image data 100, learning for the object recognition with the image data 100 alone and learning for the object recognition with the image data 100 and the millimeter-wave image data 200 are executed, and the respective parameters are generated.

Similarly to the first embodiment, the combining units 301 combine the sets of object recognition layer data 120₀ to 120₆ and the set of object recognition layer data 120₀′ to 120₆′ generated in the object recognition layer 120b and the sets of object recognition layer data 230₀ to 230₆ generated in the object recognition layer 230 with corresponding sets of data.

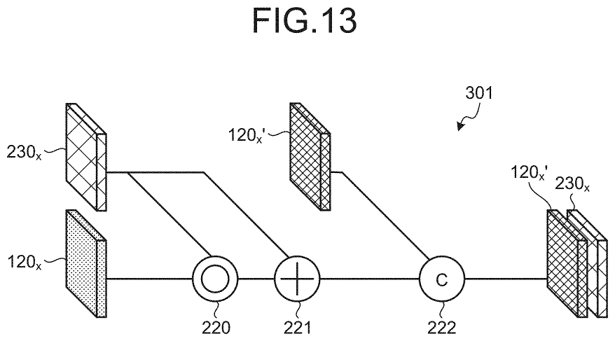

FIG. 13 is a diagram illustrating a configuration of an example of the combining unit 301 according to the third embodiment. As illustrated in FIG. 13, in the combining unit 301, a concatenating unit 222 is added to the configuration of the multiplication unit 220 and the addition unit 221 of the combining unit 300 in FIG. 8.

In the combining unit 301, the multiplication unit 220 receives, at one input end, the object recognition layer data 120ₓ in which parameters have been adjusted so that the object recognition is performed by the image data 100 alone, and receives, at the other input end, the object recognition layer data 230ₓ. The multiplication unit 220 calculates, for each pixel, a product of the object recognition layer data 120ₓ inputted to one input end thereof and the object recognition layer data 230ₓ inputted to the other input end thereof. The result of multiplication by the multiplication unit 220 is inputted to one input end of the addition unit 221. The addition unit 221 receives, at the other in put end, the object recognition layer data 230ₓ. The addition unit 221 calculates a sum of matrices for the result of multiplication by the multiplication unit 220 inputted to one input end and the object recognition layer data 230ₓ.

The output of the addition unit 221 is inputted to one input end of the concatenating unit 222. The object recognition layer data 120ₓ′ in which parameters have been adjusted so that the object recognition is performed using the image data 100 and the millimeter-wave image data 200 is inputted to the other input end of the concatenating unit 222. The concatenating unit 222 concatenates the output of the addition unit 221 and the object recognition layer data 120ₓ′.

In the concatenation processing, data of the output of the addition unit 221 and the object recognition layer data 120ₓ′ are listed, and the concatenation processing does not affect each of the output of the addition unit 221 and the object recognition layer data 120ₓ. As a result, the data outputted from the concatenating unit 222 is data including a feature amount obtained by adding the feature amount of the output of the addition unit 221 and the feature amount of the object recognition layer data 120ₓ.

The combining unit 301 performs the combining processing, so that an attention map showing the presence or absence of an object with the image data 100 alone can be generated and that the generated attention map can be multiplied by only the feature amount based on the millimeter-wave image data 200. As a result, the feature amount based on the millimeter-wave image data 200 is limited, and FP can be reduced.

Thus, according to the object recognition model 40d of the third embodiment, it is possible to generate an attention map on the basis of the image data 100 acquired by the camera 21 alone and perform the object recognition on the basis of the output obtained by combining the camera 21 and the millimeter-wave radar 23.

### 6. Fourth Embodiment

The description goes on to the fourth embodiment of the present disclosure. In the fourth embodiment, an example is described in which concatenated data of the object recognition layer data 120ₓ based on the image data 100 and the object recognition layer data 230ₓ based on the millimeter-wave image data 200 is generated and the object recognition is performed using the concatenated data.

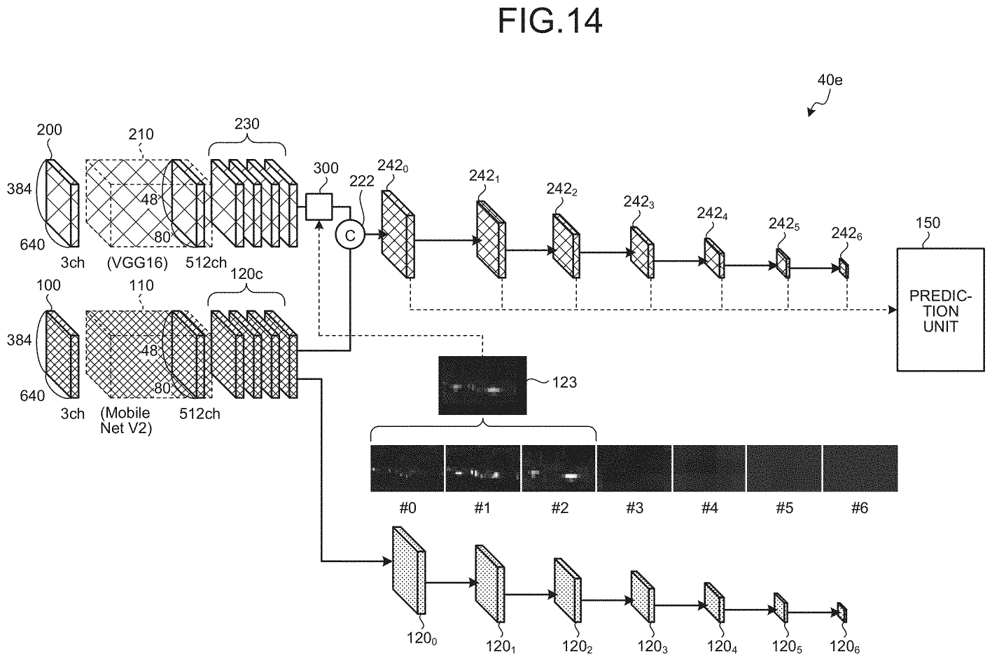

FIG. 14 is a diagram illustrating a configuration of an example of an object recognition model according to the fourth embodiment. In an object recognition model 40e according to the fourth embodiment, the sets of concatenated data for performing the object recognition processing already include the object recognition layer data 120ₓ and the object recognition layer data 230ₓ. Therefore, it is not possible to set a detection window for the object recognition layer data 230ₓ based on the millimeter-wave image data 200 in the sets of concatenated data. Thus, in the object recognition model 40e according to the fourth embodiment, processing for reducing the region outside the detection window in the millimeter-wave image data 200 is performed before the concatenating unit 222 that concatenates the object recognition layer data 120ₓ and the object recognition layer data 230ₓ.

The description is provided more specifically. In the object recognition model 40e illustrated in FIG. 14, the sets of object recognition layer data 230₀ to 230₆ (not illustrated) generated in the object recognition layer 230 on the basis of the millimeter-wave image data 200 are inputted to the combining units 300. On the other hand, an object recognition layer 120c generates the sets of object recognition layer data 120₀ to 120₆ on the basis of the image data 100, and generates an attention map by superimposing a predetermined number of sets of data of the object recognition layer data 120₀ to 120₆ thus generated. The attention map is inputted to the combining unit 300.

Note that, in the example of FIG. 14, the object recognition layer 120c generates the attention map by using image data 123 in which, among the sets of object recognition layer data 120₀ to 120₆, three sets of object recognition layer data 120₀, 120₁, and 120₂ in which the convolutional layers are sequentially adjacent are superimposed. This is not limited to the example, and for example, the object recognition layer 120c can generate the attention map by using the image data 123 in which all the sets of object recognition layer data 120₀ to 120₆ are superimposed. The present invention is not limited thereto, and the object recognition layer 120c may generate the attention map by using image data in which two or four or more sets of adjacent object recognition layer data 120ₓ are superimposed. Alternatively, the attention map can be generated by using the image data 123 in which the plurality of sets of object recognition layer data 120ₓ with the convolutional layers intermittently selected are superimposed, instead of the plurality of sets of object recognition layer data 120ₓ with the convolutional layers adjacent.

Similarly to the description using FIG. 8, the combining unit 300 obtains a product of the image data 123 and the sets of object recognition layer data 230₀ to 230₆ with the multiplication unit 220, and the addition unit 221 adds the sets of object recognition layer data 230₀ to 230₆ to the obtained product. The respective sets of combined data obtained by combining the image data 123 and the sets of object recognition layer data 230₀ to 230₆ by the combining unit 300 are inputted to one input end of the concatenating unit 222.

The sets of object recognition layer data 120₀ to 120₆ generated by the object recognition layer 120c on the basis of the image data 100 are inputted to the other input end of the concatenating unit 222. The concatenating unit 222 concatenates the respective sets of combined data inputted to one input end and the sets of object recognition layer data 120₀ to 120₆ inputted to the other input end, and generates concatenated data 242₀, 242₁, 242₂, 242₃, 242₄, 242₅, and 242₆ corresponding to the sets of object recognition layer data 120₀ to 120₆2.

The concatenated data 242₀ to 242₆ outputted from the concatenating unit 222 is inputted to the prediction unit 150.

With such a configuration, it is possible to prevent the influence of the millimeter-wave image data 200 outside the detection window on the sets of concatenated data 242₀ to 242₆ for the prediction unit 150 to perform the object recognition. Thus, according to the object recognition model 40e of the fourth embodiment, it is possible to generate an attention map on the basis of the image data 100 acquired by the camera 21 alone and perform the object recognition on the basis of the output obtained by combining the camera 21 and the millimeter-wave radar 23.

### 7. Fifth Embodiment

The description goes on to the fifth embodiment of the present disclosure. The object recognition model according to the fifth embodiment is an example in which the image data 100 one frame before is used as the image data 100 for generating the attention map.

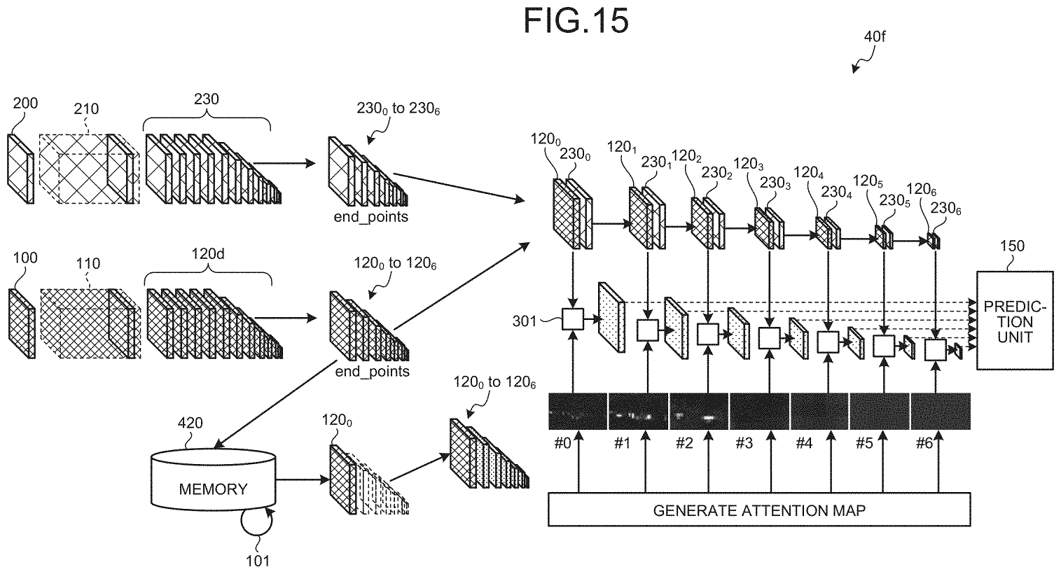

FIG. 15 is a diagram illustrating a configuration of an example of an object recognition model according to the fifth embodiment. Note that an object recognition model 40f illustrated in FIG. 15 is an example in which the configuration of the fifth embodiment is applied to the object recognition model 40d (see FIG. 12) according to the third embodiment.

In the object recognition model 40f illustrated in FIG. 15, an object recognition layer 120d generates, in the same manner as that in FIG. 12 described above, the sets of object recognition layer data 120₀ to 120₆ on the basis of the image data 100 (referred to as the image data 100 of the current frame) acquired as the frame image data of a certain frame (referred to as the current frame) by the camera 21 in the object recognition layer 120. Further, the object recognition layer 230 generates the sets of object recognition layer data 230₀ to 230₆ on the basis of the millimeter-wave image data 200 (referred to as the millimeter-wave image data 200 of the current frame) acquired by the millimeter-wave radar 23 corresponding to the current frame.

At this time, the sets of object recognition layer data 120₀ to 120₆ generated on the basis of the image data 100 of the current frame are stored in the memory 420. For example, the memory 420 can be the RAM 402 illustrated in FIG. 5. Here, it has been described that all the sets of object recognition layer data 120₀ to 120₆ are stored in the memory 420; however, this is not limited to the example.

For example, only the object recognition layer data 120₀ having the shallowest convolutional layer may be stored in the memory 420.

On the other hand, the object recognition layer 120d generates the attention map on the basis of the sets of object recognition layer data 120₀ to 120₆ that are generated on the basis of the image data 100 (referred to as the image data 100 of the past frame 101) and stored in the memory 420, the image data 100 being acquired in the past (for example, the immediately preceding frame) for the current frame by the camera 21. Here, in a case where only the object recognition layer data 120₀ having the shallowest convolutional layer is stored in the memory 420, the convolutional processing can be sequentially performed on the object recognition layer data 120₀ to generate the sets of object recognition layer data 120₁ to 120₆.

The sets of object recognition layer data 120₀ to 120₆ and the sets of object recognition layer data 230₀ to 230₆ corresponding to the current frame are inputted to the corresponding combining units 301. Further, the sets of object recognition layer data 120₀ to 120₆ generated on the basis of the image data 100 of the past frame 101 are inputted to the combining units 301 as the attention maps.

As described with FIG. 13, the combining unit 301 obtains products of the sets of object recognition layer data 120₀ to 120₆ and the sets of object recognition layer data 230₀ to 230₆ with the multiplication unit 220, and the addition unit 221 adds the sets of object recognition layer data 230₀ to 230₆ to the obtained result. The concatenating unit 222 concatenates the sets of object recognition layer data 120₀ to 120₆ generated on the basis of the image data 100 of the past frame 101 to each addition result of the addition unit 221.

In this way, the attention map is generated using the data of the past frame 101 as the image data 100, so that one or more convolutional processing in the object recognition layer 120c can be omitted, which improves the processing speed.

### 8. Sixth Embodiment

The description goes on to the sixth embodiment of the present disclosure. In the first to fifth embodiments described above, the data acquisition unit 20 includes the camera 21 and the millimeter-wave radar 23 as sensors; however, the combination of sensors included in the data acquisition unit 20 is not limited to this example. In the sixth embodiment, an example of another combination of sensors included in the data acquisition unit 20 is described.

### 8-1. First Example

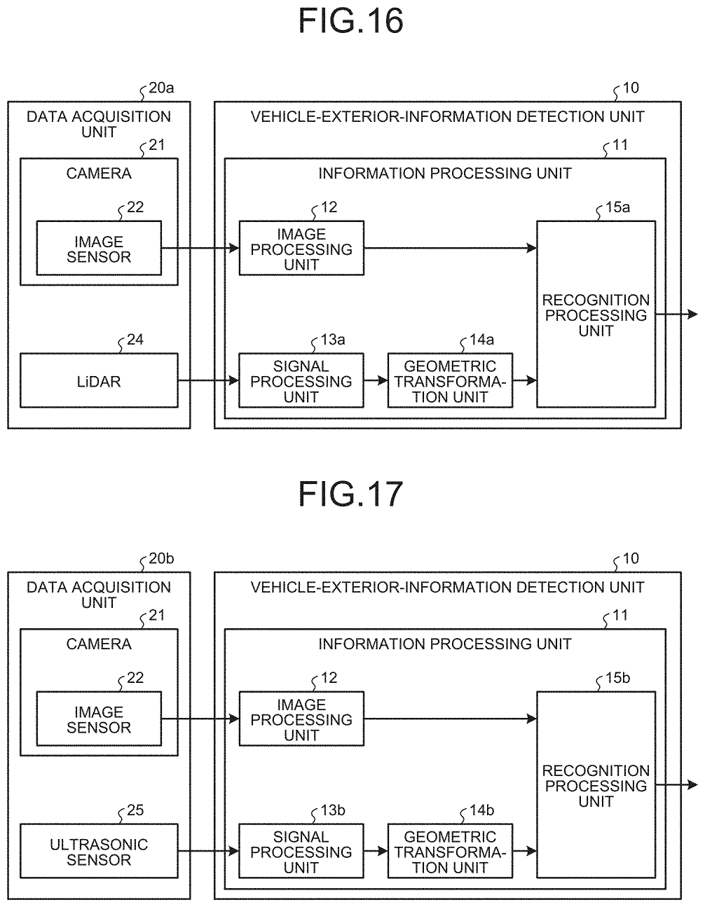

FIG. 16 is a block diagram of an example illustrating the first example of a vehicle-exterior-information detection unit and a data acquisition unit according to the sixth embodiment. As illustrated in FIG. 16, the first example is an example in which a data acquisition unit 20a includes the camera 21 and a LiDAR 24 as the sensors. The LiDAR 24 is a light reflection distance measuring sensor for measuring a distance in a LiDAR method that reflects light emitted from a light source in a target object and measures the distance, and the LiDAR 24 includes the light source and a light receiving unit.

A signal processing unit 13a generates, for example, three-dimensional group-of-points information on the basis of RAW data outputted from the LiDAR 24. A geometric transformation unit 14a transforms the three-dimensional group-of-points information generated by the signal processing unit 13a into an image viewed from the same viewpoint as the captured image by the camera 21. More specifically, the geometric transformation unit 14a transforms the coordinate system of the three-dimensional group-of-points information based on the RAW data outputted from the LiDAR 24 into the coordinate system of the captured image. The output data of the LiDAR 24 in which the coordinate system has been transformed into the coordinate system of the captured image by the geometric transformation unit 14a is supplied to a recognition processing unit 15a. The recognition processing unit 15a performs the object recognition processing using the output data of the LiDAR 24 in which the coordinate system has been transformed into the coordinate system of the captured image, instead of using the millimeter-wave image data 200 in the recognition processing unit 15 described above.

### 8-2. Second Example

FIG. 17 is a block diagram of an example illustrating the second example of a vehicle-exterior-information detection unit and a data acquisition unit according to the sixth embodiment. As illustrated in FIG. 17, the second example is an example in which a data acquisition unit 20b includes the camera 21 and an ultrasonic sensor 25 as the sensors. The ultrasonic sensor 25 sends a sound wave (ultrasonic wave) in a frequency band higher than an audible frequency band and receives a reflected wave of the ultrasonic wave to measure the distance, and the ultrasonic sensor 25 includes, for example, a transmitting element for sending an ultrasonic wave and a receiving element for receiving the same. Transmission and reception of ultrasonic waves may be performed by one element. For example, the ultrasonic sensor 25 can obtain the three-dimensional group-of-points information by repeatedly transmitting and receiving an ultrasonic wave at a predetermined cycle while scanning the transmission direction of the ultrasonic wave.

A signal processing unit 13b generates, for example, the three-dimensional group-of-points information on the basis of data outputted from the ultrasonic sensor 25. A geometric transformation unit 14b transforms the three-dimensional group-of-points information generated by the signal processing unit 13b into an image viewed from the same viewpoint as the captured image by the camera 21. More specifically, the geometric transformation unit 14b transforms the coordinate system of the three-dimensional group-of-points information based on the data outputted from the ultrasonic sensor 25 into the coordinate system of the captured image. The output data of the ultrasonic sensor 25 in which the coordinate system has been transformed into the coordinate system of the captured image by the geometric transformation unit 14b is supplied to a recognition processing unit 15b. The recognition processing unit 15b performs the object recognition processing using the output data of the ultrasonic sensor 25 in which the coordinate system has been transformed into the coordinate system of the captured image, instead of using the millimeter-wave image data 200 in the recognition processing unit 15 described above.

### 8-3. Third Example

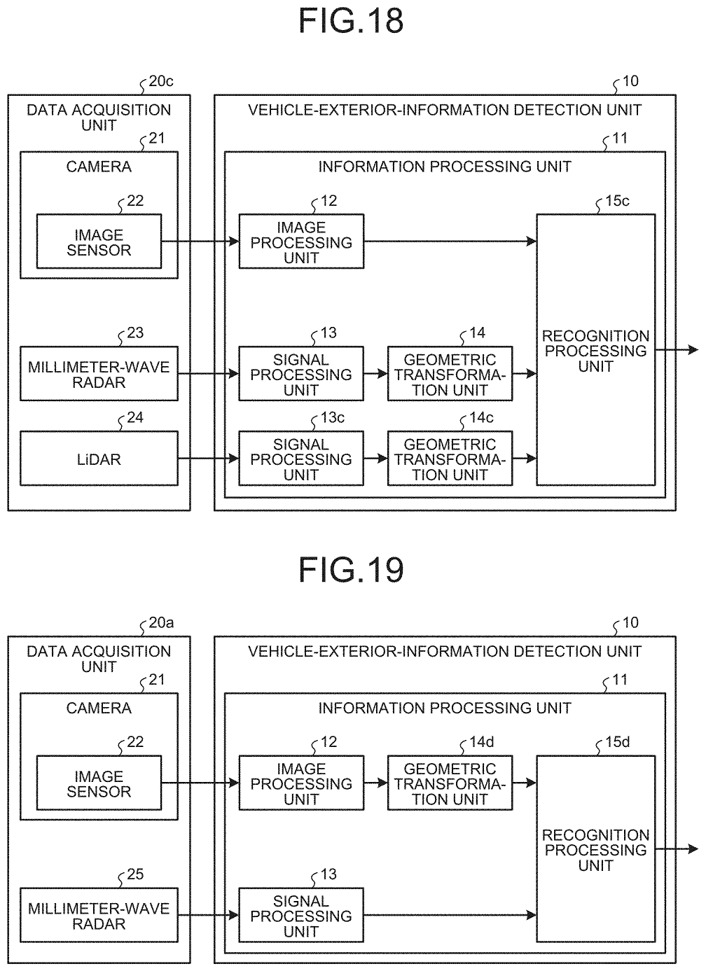

FIG. 18 is a block diagram of an example illustrating the third example of a vehicle-exterior-information detection unit and a data acquisition unit according to the sixth embodiment. As illustrated in FIG. 18, the third example is an example in which a data acquisition unit 20c includes the camera 21, the millimeter-wave radar 23, and the LiDAR 24 as sensors.

In the vehicle-exterior-information detection unit 10 illustrated in FIG. 18, the millimeter-wave data outputted from the millimeter-wave radar 23 is inputted to the signal processing unit 13. The signal processing unit 13 performs processing similar to the processing described with reference to FIG. 2 on the inputted millimeter-wave data to generate a millimeter-wave image. The geometric transformation unit 14 performs a geometric transformation on the millimeter-wave image generated by the signal processing unit 13 to transform the millimeter-wave image into an image having the same coordinate system as that of the captured image. The image (referred to as a transformed millimeter-wave image) obtained by transforming the millimeter-wave image by the geometric transformation unit 14 is supplied to a recognition processing unit 15c.

Further, in the vehicle-exterior-information detection unit 10, the RAW data outputted from the output of the LiDAR 24 is inputted to a signal processing unit 13c. The signal processing unit 13c generates, for example, the three-dimensional group-of-points information on the basis of the RAW data inputted from the LiDAR 24. A geometric transformation unit 14c transforms the three-dimensional group-of-points information generated by the signal processing unit 13c into an image viewed from the same viewpoint as the captured image by the camera 21. The image (referred to as a transformed LiDAR image) obtained by transforming the three-dimensional group-of-points information by the geometric transformation unit 14 is supplied to the recognition processing unit 15c.

The recognition processing unit 15c combines the transformed millimeter-wave image and the transformed LiDAR image inputted from each of the geometric transformation units 14 and 14c, and performs the object recognition processing using the combined image instead of using the millimeter-wave image data 200 in the recognition processing unit 15. Here, the recognition processing unit 15c can concatenate the transformed millimeter-wave image and the transformed LiDAR to integrate the transformed millimeter-wave image and the transformed LiDAR.

### 8-4. Fourth Example

FIG. 19 is a block diagram of an example illustrating the fourth example of a vehicle-exterior-information detection unit and a data acquisition unit according to the sixth embodiment. As illustrated in FIG. 19, in the fourth example, the data acquisition unit 20a including the camera 21 and the millimeter-wave radar 23 described with reference to FIG. 16 is applied. On the other hand, in the vehicle-exterior-information detection unit 10, the image processing unit 12 and a geometric transformation unit 14d are connected to the output of the camera 21, and only the signal processing unit 13 is connected to the millimeter-wave radar 23.

In the vehicle-exterior-information detection unit 10, the image processing unit 12 performs predetermined image processing on the captured image outputted from the camera 21. The captured image that has been subjected to the image processing by the image processing unit 12 is supplied to the geometric transformation unit 14d. The geometric transformation unit 14d transforms the coordinate system of the captured image into the coordinate system of the millimeter-wave data outputted from the millimeter-wave radar 23. The captured image (referred to as a transformed captured image) obtained by transforming into the coordinate system of the millimeter-wave data by the geometric transformation unit 14d is supplied to a recognition processing unit 15d.

On the other hand, in the vehicle-exterior-information detection unit 10, the millimeter-wave data outputted from the millimeter-wave radar 23 is inputted to the signal processing unit 13. The signal processing unit 13 performs predetermined signal processing on the inputted millimeter-wave data to generate a millimeter-wave image on the basis of the millimeter-wave data. The millimeter-wave image generated by the signal processing unit 13 is supplied to the recognition processing unit 15d.

The recognition processing unit 15d can use the millimeter-wave image data based on the millimeter-wave image supplied by the signal processing unit 13, for example, instead of using the image data 100 in the recognition processing unit 15, and can use the transformed captured image supplied by the geometric transformation unit 14d instead of using the millimeter-wave image data 200. For example, in a case where the performance of the millimeter-wave radar 23 is high and the performance of the camera 21 is low, the configuration according to the fourth example may be adopted.

### 8-5. Fifth Example

In the first to fourth examples of the sixth embodiment described above, the camera 21 and a sensor of a type different from that of the camera 21 are combined; however, this is not limited to the example. For example, as the fifth example of the sixth embodiment, a combination of cameras 21 having different characteristics can be applied. As an example, it is possible to apply a combination of the first camera 21 using a telephoto lens having a narrow angle of view and capable of imaging over a long distance and the second camera 21 using a wide angle lens having a wide angle of view and capable of imaging a wide range.

### 8-6. Sixth Example

The description goes on to the fifth example of the sixth embodiment. The fifth example is an example in which the configuration of the recognition processing unit 15 is switched according to conditions. Note that, for the sake of explanation, the recognition processing unit 15 (the object recognition model 40a) according to the first embodiment is described below as an example.

As an example, the use/non-use of the attention map may be switched according to the weather or the scene. For example, at night and under rainy conditions, it may be difficult to recognize an object in an image captured by the camera 21. In such a case, the object recognition is performed using only the output of the millimeter-wave radar 23. Further, as another example, it is possible to change how to use the attention map in a case where one of the plurality of sensors included in the data acquisition unit 20 does not normally operate. For example, in a case where the normal image data 100 is not outputted due to a malfunction of the camera 21 or the like, the object recognition is performed at a recognition level similar to that in a case where the attention map is not used. As still another example, in a case where the data acquisition unit 20 includes three or more sensors, generating a plurality of attention maps is possible on the basis of outputs of the plurality of sensors. In such a case, a plurality of attention maps generated on the basis of the outputs of the sensors may be combined.

The effects described in the present specification are merely examples and are not limited, and other effects may be provided.

Further, the present technology may also be configured as below.

(1) An information processing apparatus comprising:

a recognition processing unit configured to perform recognition processing for recognizing a target object by adding, to an output of a first sensor, region information that is generated according to object likelihood detected in a process of object recognition processing based on an output of a second sensor different from the first sensor.

(2) The information processing apparatus according to the above (1), wherein

the recognition processing unit

uses an object recognition model obtained by machine learning to perform the recognition processing, and

the object recognition model generates the region information in one layer of a first convolutional layer generated on a basis of the output of the second sensor, and adds the region information generated to a layer, corresponding to the layer in which the region information has been generated, of a second convolutional layer generated on a basis of the output of the first sensor.

(3) The information processing apparatus according to the above (1), wherein

the recognition processing unit

uses an object recognition model obtained by machine learning to perform the recognition processing, and

the object recognition model generates the region information in a plurality of layers included in a first convolutional layer generated on a basis of the output of the second sensor, and adds the region information generated to each of a plurality of layers of a second convolutional layer, corresponding one-to-one to each of the plurality of layers in which the region information has been generated, generated on a basis of the output of the first sensor.

(4) The information processing apparatus according to the above (3), wherein

the recognition processing unit

generates the region information in each of a predetermined number of first convolutional layers of the first convolutional layer.

(5) The information processing apparatus according to any one of the above (1) to (4), wherein

the second sensor is an image sensor.

(6) The information processing apparatus according to the above (5), wherein

the first sensor is any one of a millimeter-wave radar, a light reflection distance measuring sensor, and an ultrasonic sensor.

(7) The information processing apparatus according to the above (5), wherein

the first sensor

includes two or more sensors of the image sensor, a millimeter-wave radar, a light reflection distance measuring sensor, and an ultrasonic sensor, and an output obtained by combining outputs of the two or more sensors is used as the output of the first sensor.

(8) The information processing apparatus according to any one of the above (1) to (4), wherein

the first sensor is an image sensor, and

the second sensor is any one of a millimeter-wave radar, a light reflection distance measuring sensor, and an ultrasonic sensor.

(9) The information processing apparatus according to any one of the above (1) to (8), wherein

the recognition processing unit

emphasizes a region, of the output of the first sensor, corresponding to a region in which the object likelihood in the output of the second sensor is equal to or greater than a first threshold.

(10) The information processing apparatus according to any one of the above (1) to (9), wherein

the recognition processing unit

reduces a region, of the output of the first sensor, corresponding to a region in which the object likelihood in the output of the second sensor is less than a second threshold.

(11) The information processing apparatus according to any one of the above (1) to (10), wherein

the recognition processing unit

uses an output one frame before the second sensor to generate the region information.

(12) The information processing apparatus according to any one of the above (1) to (11), wherein

the recognition processing unit

concatenates the output of the second sensor to the region information.

(13) An information processing system comprising:

a first sensor;

a second sensor different from the first sensor; and

an information processing apparatus including a recognition processing unit configured to perform recognition processing for recognizing a target object by adding, to an output of the first sensor, region information that is generated according to object likelihood detected in a process of object recognition processing based on an output of the second sensor.

(14) An information processing program for causing a computer to execute processing comprising:

recognition processing step for performing recognition processing for recognizing a target object by adding, to an output of a first sensor, region information that is generated according to object likelihood detected in a process of object recognition processing based on an output of a second sensor different from the first sensor.

(15) An information processing method comprising:

executing, by a processor,

recognition processing step for performing recognition processing for recognizing a target object by adding, to an output of a first sensor, region information that is generated according to object likelihood detected in a process of object recognition processing based on an output of a second sensor different from the first sensor.

### REFERENCE SIGNS LIST

10 VEHICLE-EXTERIOR-INFORMATION DETECTION UNIT
11 INFORMATION PROCESSING UNIT
12 IMAGE PROCESSING UNIT
13, 13a, 13b, 13c SIGNAL PROCESSING UNIT
14, 14a, 14b, 14c, 14d GEOMETRIC TRANSFORMATION UNIT
15a, 15b, 15c, 15d RECOGNITION PROCESSING UNIT
20, 20a, 20b, 20c DATA ACQUISITION UNIT
21 CAMERA
22 IMAGE SENSOR
23 MILLIMETER-WAVE RADAR
24 LIDAR
25 ULTRASONIC SENSOR
30 LEARNING SYSTEM
40, 40a, 40b, 40c, 40d, 40e, 40f OBJECT RECOGNITION MODEL
41a, 41b, 41c, 110, 210 FEATURE EXTRACTION LAYER
100, 100a, 100b IMAGE DATA
120, 120a, 120b, 120c OBJECT RECOGNITION LAYER
120₀, 120₁, 120₂, 120₃, 120₄, 120₅, 120₆, 120ₓ, 120₀′, 120₁′, 120₂′, 120₃′, 120₄′, 120₅′, 120₆′, 122₁, 122₂, 122₃, 122₄, 122₅, 122₆, 230₀, 230₁, 230₂, 230₃, 230₄, 230₅, 230₆, 230ₓ OBJECT RECOGNITION LAYER DATA
150 PREDICTION UNIT
200 MILLIMETER-WAVE IMAGE DATA
220 MULTIPLICATION UNIT
221 ADDITION UNIT
222 CONCATENATING UNIT
230 OBJECT RECOGNITION LAYER
242₀, 242₁, 242₂, 242₃, 242₄, 242₅, 242₆ CONCATENATED DATA
300, 301 COMBINING UNIT
310₀, 310₁, 310₂, 310₃, 310₄, 310₅, 310₆ COMBINED OBJECT RECOGNITION LAYER DATA

1. An information processing apparatus comprising:
a recognition processing unit configured to perform recognition processing for recognizing a target object by adding, to an output of a first sensor, region information that is generated according to object likelihood detected in a process of object recognition processing based on an output of a second sensor different from the first sensor.

2. The information processing apparatus according to claim 1, wherein
the recognition processing unit
uses an object recognition model obtained by machine learning to perform the recognition processing, and
the object recognition model generates the region information in one layer of a first convolutional layer generated on a basis of the output of the second sensor, and adds the region information generated to a layer, corresponding to the layer in which the region information has been generated, of a second convolutional layer generated on a basis of the output of the first sensor.

3. The information processing apparatus according to claim 1, wherein
the recognition processing unit
uses an object recognition model obtained by machine learning to perform the recognition processing, and
the object recognition model generates the region information in a plurality of layers included in a first convolutional layer generated on a basis of the output of the second sensor, and adds the region information generated to each of a plurality of layers of a second convolutional layer, corresponding one-to-one to each of the plurality of layers in which the region information has been generated, generated on a basis of the output of the first sensor.

4. The information processing apparatus according to claim 3, wherein
the recognition processing unit
generates the region information in each of a predetermined number of first convolutional layers of the first convolutional layer.

5. The information processing apparatus according to claim 1, wherein
the second sensor is an image sensor.

6. The information processing apparatus according to claim 5, wherein
the first sensor is any one of a millimeter-wave radar, a light reflection distance measuring sensor, and an ultrasonic sensor.

7. The information processing apparatus according to claim 5, wherein
the first sensor
includes two or more sensors of the image sensor, a millimeter-wave radar, a light reflection distance measuring sensor, and an ultrasonic sensor, and an output obtained by combining outputs of the two or more sensors is used as the output of the first sensor.

8. The information processing apparatus according to claim 1, wherein
the first sensor is an image sensor, and
the second sensor is any one of a millimeter-wave radar, a light reflection distance measuring sensor, and an ultrasonic sensor.

9. The information processing apparatus according to claim 1, wherein
the recognition processing unit
emphasizes a region, of the output of the first sensor, corresponding to a region in which the object likelihood in the output of the second sensor is equal to or greater than a first threshold.

10. The information processing apparatus according to claim 1, wherein
the recognition processing unit
reduces a region, of the output of the first sensor, corresponding to a region in which the object likelihood in the output of the second sensor is less than a second threshold.

11. The information processing apparatus according to claim 1, wherein
the recognition processing unit
uses an output one frame before the second sensor to generate the region information.

12. The information processing apparatus according to claim 1, wherein
the recognition processing unit
concatenates the output of the second sensor to the region information.

13. An information processing system comprising:
a first sensor;
a second sensor different from the first sensor; and
an information processing apparatus including a recognition processing unit configured to perform recognition processing for recognizing a target object by adding, to an output of the first sensor, region information that is generated according to object likelihood detected in a process of object recognition processing based on an output of the second sensor.

14. An information processing program for causing a computer to execute processing comprising:
recognition processing step for performing recognition processing for recognizing a target object by adding, to an output of a first sensor, region information that is generated according to object likelihood detected in a process of object recognition processing based on an output of a second sensor different from the first sensor.

15. An information processing method comprising:
executing, by a processor,
recognition processing step for performing recognition processing for recognizing a target object by adding, to an output of a first sensor, region information that is generated according to object likelihood detected in a process of object recognition processing based on an output of a second sensor different from the first sensor.
